(19) United States
(12) Patent Application Publication
(10) Pub. No.: US 2019/0060820 A1
(43) Pub. Date: Feb. 28, 2019

(54) SHAPED ATTRITION RESISTANT PARTICLES FOR CO2 CAPTURING AND CONVERSION

(71) Applicant: ANTECY B.V., Hoevelaken (NL)

(72) Inventor: PAUL O'CONNOR, HOEVELAKEN (NL)

(21) Appl. No.: 16/081,071

(22) PCT Filed: Feb. 23, 2017
(86) PCT No.: PCT/EP2017/054121

§ 371 Date: Aug. 30, 2018

(30) Foreign Application Priority Data
Mar. 1, 2016 (EP) EP16158029.5
Dec. 8, 2016 (EP) EP16202944.1

(51) Int. Cl. B01D 53/02; B01D 53/62; B01D 53/83; B01J 20/04; B01J 20/20; B01J 20/22; B01J 20/28

(52) U.S. Cl. CPC B01D 53/025; B01D 53/62; B01D 53/83; B01J 20/041; B01J 20/20; B01J 20/223; B01J 2220/4825; B01J 20/2803; B01D 2251/304; B01D 2251/306; B01D 2251/606; B01D 2253/25; B01D 2257/504; B01J 20/28011

(57) ABSTRACT

The present invention relates to Cellulose and/or Lignin based materials used as catalyst and/or sorbent support, carrier and/or binder in combination with an inorganic binder, leading to strong but flexible structures such as porous monoliths, wire mesh or shaped particles (extrudates, beads, pellets, microspheres) which can accommodate variations in catalyst and/or sorbent loadings as well as temperature and pressure fluctuations and humidity swings, this without loss of sorption capacity and mechanical integrity to prevent attrition, fines, losses etc. These sorbent/catalyst can be produced from waste biomass and can be recycled and reused, dissolved and re-precipitated making use of solvents like ZnCI2.

### PROBLEM TO BE SOLVED

There is presently a need for capturing CO2 from gaseous streams such as Flue gas from combustion, CO2 wastes from other sources and even directly CO2 from Air in order to limit human impact on Global CO2 levels and related global weather and climate changes.

Preferably the captured CO2 should be able to be converted to valuable components (fuels, chemicals, building materials, polymers) or stored permanently as in the various Carbon Capturing and sequestration schemes being studied today.

### STATE-OF-THE-ART

The existing technology to capture CO2 from gas streams is based on a wet scrubbing process by Gas-Liquid contacting which is mass transfer limited, making use of Amines. These amines are costly and suffer from issues related to corrosion, amine degradation and solvent losses. Above all the amines also have toxicity issues and can degrade to nitrosamines, which are carcinogenic. Resuming the present state of the art technology for the capturing of CO2 exhibits several serious challenges:
Liquid-Gas (CO2) contacting which is mass transfer limited
Amine toxicity and potential carcinogenic
Amine degradation and costs

There is a need for a technology, which addresses these drawbacks in order to enable low cost CO2 capturing, conversion and/or sequestration.

Solid-Gas adsorption have been developed based on amines, but these exhibit similar issues as the liquid amine systems, whereby the cost, complexity and low stability of these systems will lead to excessive high costs.

Low cost alternative for amines are carbonate systems as reported by:
SOO CHOOL LEE ET AL: “CO2 absorption and regeneration of alkali metal-based solid sorbents”, CATALYSIS TODAY 111, 15 Dec. 2015 (2015-12-15), pages 385-390, XP025116763, DOI: 10.1016/j.cattod.2005.10.051.
KRIJN P. DE JONG ET AL: “Carbon Nanofiber-Supported K₂CO₃ as an Efficient Low-Temperature Regenerable CO₂ Sorbent for Post-Combustion Capture”, INDUSTRIAL & ENGINEERING CHEMISTRY RESEARCH 52, 14 Aug. 2013 (2013-08-14), pages 12812-12818, DOI: 10.1021/ie4017072.

The most preferred carbonated are those supported on Carbon instead of inorganic supports, see: SOO CHOOL LEE ET AL: “CO2 absorption and regeneration of alkali metal-based solid sorbents”, CATALYSIS TODAY 111, 15 Dec. 2015 (2015-12-15), pages 385-390, XP025116763, DOI: 10.1016/j.cattod.2005.10.051. KRIJN P. DE JONG ET AL: “Carbon Nanofiber-Supported K₂CO₃ as an Efficient Low-Temperature Regenerable CO₂ Sorbent for Post-Combustion Capture”, INDUSTRIAL & ENGINEERING CHEMISTRY RESEARCH 52, 14 Aug. 2013 (2013-08-14), pages 12812-12818, DOI: 10.1021/ie4017072.

Unfortunately Existing Carbon supports are often brittle and therefore have a limited life span, especially when they also need to be transported, such as in conveyor, solids flow, fluidized flow conditions, or dilute solids-gas transport conditions. See: WO 2016050944 (ANTECY B.V. [NL]) 7 Apr. 2016 (2016-04-07).
YOUNG CHEOL PARK ET AL: “Performance analysis of K-based KEP-CO2P1 solid sorbents in a bench-scale continuous dry-sorbent CO₂ capture process”, KOREAN J. CHEM. ENG., vol. 33, no. 1, accepted 27 Apr. 2015 (2015-04-27), pages 73-79 (2016), pISSN: 0256-1115, eISSN: 1975-7220, DOI: 10.1007/s11814-015-0091-1.

On the other hand there is a strong need to increase the number of adsorption/desorption cycles per day (N) in order to reduce the quantity of Sorbent required per CO2 to be adsorbed as this in fact will have a significant impact on the physical size of the Absorber and Desorber and therefore also the capital expenditure (CAPEX) costs.

To improve the performance of the overall process and to reduce the costs besides solid sorbent capacity, the sorbent kinetics (mass transfer and accessibility of the sorbent sites) and the integrity of the sorbent physical properties (flow ability, particle integrity, strength and attrition resistance) are of great importance.

Preferably free flowing particles are required to transport the sorbent within short cycles from hours to minutes and possibly even seconds from the absorber to the desorber stage.

The foregoing requirements are usually contradictory.

### THE INVENTION

The present invention solves this problem by producing shaped particles for CO2 capturing combining a hybrid organic-inorganic sorbent comprising:
1) An organic Carbon based support and/or binder
2) An inorganic support and/or binder
3) Inorganic oxides and/or Carbonates dispersed on 1) and/or 2) as CO2 capturing sorbent and/or conversion catalysts
4) Optionally a Nitrogen containing organic component can be added to further enhance the performance of the sorbent

This combination addresses the requirements set in the foregoing.

### SPECIFIC EMBODIMENTS OF THIS INVENTION

### Example 1

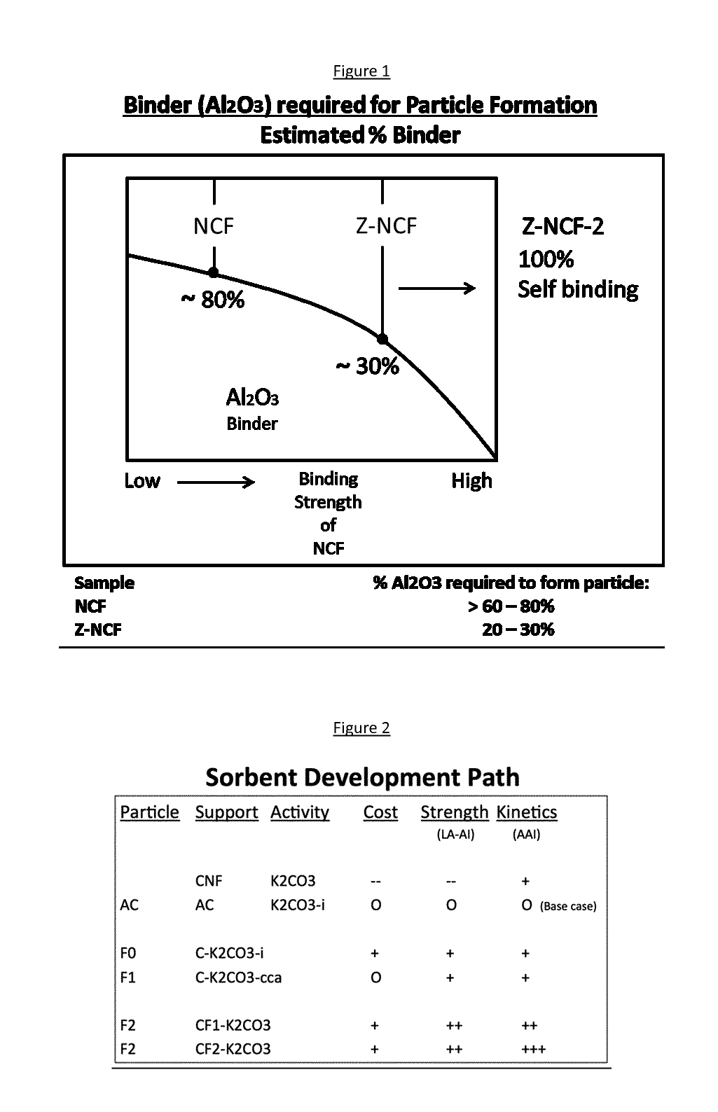

### Compositions Containing: (See FIG. 1)

Al2O3: Alumina Binder
C-NF: Carbon Nano Fibers (Commercial)
Z-NCF Carbon Fibers produced via ZnCl2 cellulose treatment as described in WO 2016/087186 whereby the hydrolysis of cellulose is minimized.

### Example 2

The base case for the Sorbent development, are shaped particles produced with Active Carbon as particle and support impregnated with K2CO3. The physical properties of these particles are limited (strength) as the accessibility (kinetics) meaning that the number of cycles and hence performance will be limited. (See FIG. 2)

The technology as developed is to make use of the high accessibility and strength of inorganic based catalysts as applied in Fluid Catalytic Cracking with the good sorbent performance of the systems as indicated by Krijn de Jong et al.

### Examples

### F0:

As base a High accessibility inorganic, e.g. Alumina binder sorbent particle is applied wherein K2CO3 impregnated Active Carbon particles are imbedded.

### F1:

A Carbon coated catalysts (CCA) is formed, for instance by treating a High Accessibility Inorganic, e.g. Alumina binder sorbent system with an organic Potassium molecule (e.g. Potassium Acetate) under pyrolysis conditions.

### F2:

Potassium loaded nano-cellulose fibers (CF-K2CO3) are imbedded in a High Accessibility Inorganic, e.g. Alumina binder sorbent system. The nano-cellulose can be partially of fully carbonized in-situ to form Carbon fibers.

### F3:

Same as F2 whereby part or all of the role of binding is replaced by biomass (waste) based nano-cellulose and/or lignin.

### F4:

A full Cellulose/Lignin based high accessibility strong particle with K2CO3. Which may be wholly or fully carbonized to improve the CO2 adsorption capacity and kinetics

### Example 3

The following are compositions, which are embodiments of this invention.

### Base Case:

Active Carbon Impregnated with 10% and 25% K2CO3

| | | | | |
|---|---|---|---|---|
| AKₑ | AC | 10 and 25% K2CO3 | Extrudates. Beads | 2-3 mm |
| AKₚ | AC | 10 and 25% K2CO3 | Microspheres, MS | |

Pure Cellulose and Lignin Impregnated with 10% K2CO3

| | | | |
|---|---|---|---|
| CK | Cellulose | 10% K2CO3 | MS |
| LK | Lignin | 10% K2CO3 | MS |

The nano-cellulose and/or lignin can be partially of fully carbonized in-situ.

### Cellulose Produced by ZnCl2 Dissolution Followed by Precipitation

As described in WO 2016/087186.

| | | | |
|---|---|---|---|
| ZCK | Z-NC | 10% K2CO3 | MS - impregnated with K2CO3 |
| ZCZ | Z-NC | 10% ZnO | MS - impregnated with ZnO |
| ZCA | Z-NC | 10% MEA (Amine) | MS - impregnated Amine (MEA) |

The nano-cellulose can be partially or fully carbonized in-situ.

Dried Algae Impregnated with K2CO3

| | | | |
|---|---|---|---|
| DAK | Algae | 10% K2CO3 | MS |

The Algae can be partially or fully carbonized in-situ.

Sorbent compositions comprising 20%, 50% and 80% of a binding (peptizable) Alumina incorporating 80%, 50% and 20% of the above compositions

These compositions are evaluated by the following performance tests:
Adsorption at 3 CO2 levels: 400 ppm, 2%, 10%
Desorption with Steam at T=80° C. and T=120° C.
Particle strength before and after >10 cycles
CO2 adsorption capacity before and after >10 cycles

### Background Information to be Included in Disclosure:

The following describes the large effect of N (Number of cycles per day) on the Sorbent performance:

### Dry Sorbent Performance—Criteria

### Solid Sorbent Net Capacity: SC

SC=Molecules or m³ CO₂ produced per m³ solid Sorbent per cycle

### Number of Cycles per day: N

CO₂ m³ produced: CO₂ (m³)
Sorbent volume: S (m³)

CO₂(m³)=S(m³)×SC×N

Sorbent−Reactor Volume−CO₂(m³)/(SC×N)
Large effect of N on Sorbent and reactor volume and costs
High N requires fast kinetics (mass transfer) and strong particles
High N requires robust and stable sorbent. (K₂CO₃!)

As indicated above besides solid sorbent capacity, the sorbent kinetics (mass transfer and accessibility of the sorbent sites) and the integrity of the sorbent physical properties (flow ability, particle integrity, strength and attrition resistance) are of great importance.

Free flowing particles are required to transport the sorbent within short cycles (minutes, seconds) from the absorber to the desorber stage. The foregoing requirements are usually contradictory.

This invention is based on a combination of the chemistry of Inorganic Oxides and/or Carbonate systems such as the K2CO3 systems as investigated by Krijn de Jong et al (2013) on a Carbon based support.
See: KRIJN P. DE JONG ET AL: “Carbon Nanofiber-Supported K₂CO₃ as an Efficient Low-Temperature Regenerable CO₂ Sorbent for Post-Combustion Capture”, INDUSTRIAL & ENGINEERING CHEMISTRY RESEARCH 52, 14 Aug. 2013 (2013-08-14), pages 12812-12818, DOI: 10.1021/ie4017072.

Obviously the Carbon Nano Fibers (CNF) as mentioned by de Jong et al cannot be used as such because of the high costs (±10 Euro's/kg) and the difficulty to form into attrition resistant hard sorbent particles. One can foresee a similar problem with Lackner's (2016)“Shaggy” sorbents, which (Ref: https://www.insidescience.org/what's-white-shaggy-and-could-help-reduce-carbon-dioxide-80) are very susceptible to attrition and difficult to form into a flowing sorbent.

### Discussion of State-of-the Art

(D1) CHRISTOPH GEBALD ET AL: “Amine-Based Nanofibrillated Cellulose As Adsorbent for CO2 Capture from Air”, ENVIRONMENTAL SCIENCE & TECHNOLOGY, vol. 45, no. 20, 15 Oct. 2011 (2011-10-15), pages 9101-9108, XP055220521, US ISSN: 0013-936X, DOI: 10.1021/es202223p.

Christoph Gebald et al. (D1) discusses the synthesis of an organic amine grafted nano-fibrillated cellulose as adsorbent. So Cellulose is used as a carrier and binder, which will not be sufficiently attrition resistant. Furthermore our invention specifically avoids the amines and the complicated synthesis of grafting on cellulose, and uses simple low cost inorganic carbonates as the CO2 sorbent and hence is not disclosed by Gebald et al. Furthermore Gebald et al only use cellulose as binder and do not include a second inorganic binder system as disclosed in our invention.
(D2) ARNAUD DEMILECAMPS ET AL: “Cellulose-silica composite aerogels from “one-pot” synthesis”, CELLULOSE, vol. 21, no. 4, 6 Jun. 2014 (2014-06-06), pages 2625-2636, XP055298224, Netherlands ISSN: 0969-0239, DOI: 10.1007/s10570-014-0314-3.

Arnaud Demilecamps et al (D2) discusses a cellulose silica aerogel, which as they show has a very low density (0.1-0.3 g/cm3) which implies a very poor attrition resistance and also is not suitable for transport or handling as required in our invention. Shaped particles as claimed in our invention can be in the form of extrudates, beads, pellets and/or microspheres, whereby density is significantly higher (>0.5 g/cm3).
(D3) EP 2 100 972 A1 (BIOECON INT HOLDING NV [AN]) 16 Sep. 2009 (2009-09-16).

EP 2100972A1 (D3) discusses the dissolution of Cellulosic materials in ZnCl2, but does not disclose the application as a catalyst/sorbent component and does not disclose the use in combination with a second inorganic binder to produce attrition resistant shaped particles as disclosed in our invention.
(D4) MARIA CIOBANU ET AL: IN-SITU CELLULOSE FIBRES LOADING WITH CALCIUM CARBONATE PRECIPITATED BY DIFFERENT METHODS”, CELLULOSE CHEMISTRY AND TECHNOLOGY, vol. 44, no. 9, 1 Sep. 2010 (2010-09-01), pages 379-387, XP055298232, RO ISSN: 0576-9787.

Maria Ciobanu et al (D4) discusses the loading of Calcium Carbonate on Cellulose. For the application intended Calcium is not a suitable sorbent, as very high temperatures are required to release CO2. Furthermore this publication does not disclose the application as a catalyst/sorbent component and does not disclose the use in combination with a second inorganic binder to produce attrition resistant shaped particles.

1. Attrition resistant shaped porous materials or particles comprising:
a) an organic carbon based support and/or binder selected from carbon fibers, active carbon particles, carbon coated on an inorganic binder sorbent system and material from biomass origin which is partially or wholly carbonized,
b) an inorganic binder and support selected from alumina, silica-slumina, magnesia, titania and/or clays containing silica and/or magnesia and/or titania and/or alumina and/or zinc,
c) inorganic oxides and/or carbonates dispersed on a) and/or b) as CO₂ capturing sorbent and/or as conversion catalysts whereby c) comprises an inorganic carbonate, preferably selected from K₂CO₃, KHCO₃, NaCO₃, and NaHCO₃.

2. Attrition resistant shaped porous materials or particles of claim 1 comprising:
a) 20-80% of the organic Carbon based material,
b) 20-80% of the inorganic support and/or binder,
c) inorganic oxides and/or Carbonates dispersed on a) and/or b) as CO₂ capturing sorbent and/or as conversion catalysts.

3. Attrition resistant shaped porous materials or particles of claim 1
wherein inorganic oxides and/or Carbonates are dispersed on a) as CO₂ capturing sorbent and/or conversion catalysts.

4. Attrition resistant shaped porous materials or particles of claim 1 being a transportable and/or fluidizable particles with a particle density of at least 0.4 g/cm³, preferably higher than 0.5 g/cm³.

5. Attrition resistant shaped porous materials or particles of claim 1 whereby b) is Alumina.

6. Attrition resistant shaped porous materials or particles of claim 1, whereby the inorganic component is peptizable forming particles smaller than 1 microns and has binding properties, which, contributes to the physical integrity of the overall particle.

7. Attrition resistant shaped porous materials or particles of claim 2 whereby a) is a cellulosic material with a particle size smaller than 3 microns, preferably with an average particle size of 1 microns or less.

8. (canceled)

9. Attrition resistant shaped porous materials or particles of claim 2 whereby a) comprises material from a biomass origin being cellulose, lignin, seaweed and/or algae.

10. Attrition resistant shaped porous materials or particles of claim 1 whereby the particles produced are smaller than 5 mm, preferably microspheres smaller than 1 mm.

11. (canceled)

12. (canceled)

13. Attrition resistant shaped porous materials or particles of claim 1 whereby c) comprises inorganic metal oxides preferably single or mixed oxides consisting of Zn, Fe, Cu, Ca and Mg.

14. Attrition resistant shaped porous materials or particles of claim 13, whereby an organic nitrogen-containing compound, such as an amine (e.g. monoethanolamine (MEA), is added to the particle composition.

15. Attrition resistant shaped porous materials or particles of claim 14, whereby the nitrogen containing compound originates from biomass species, or biomass waste such as Lignin or Algae.

16. Attrition resistant shaped porous materials or particles of claim 1 whereby the ratio of organic binder to inorganic binder is greater than 1, preferably greater than 5.

17. (canceled)

18. A process to capture CO₂ comprising:
step 1 in which CO₂ is adsorbed from a CO₂ containing stream with attrition resistant shaped porous materials or particles according to claim 1 as a
a).

19. The process to capture and convert CO₂ according to claim 18 further comprising:
step 2 in which CO₂ is desorbed in a more concentrated form and
step 3 in which the concentrated CO₂ is converted with hydrogen, or
step 2 in which the absorbed CO₂ from Step 1 is converted with hydrogen to form a liquid hydrocarbon with the sorbent acting as catalyst, or
step 2 in which the absorbed CO₂ from Step 1 is converted with hydrogen to form a carbon fiber, or
step 2 in which the absorbed CO₂ from Step 1 is converted with a biocatalyst/enzyme.

20. (canceled)

21. (canceled)

22. Attrition resistant shaped porous sorbent particles according to claim 1, being a sorbent particle comprising high accessibility inorganic binder, preferably Alumina, wherein K₂C0₃ impregnated Active Carbon particles are imbedded or
a sorbent particle obtainable by treating a High Accessibility Inorganic binder, preferably Alumina sorbent system with an organic Potassium molecule, preferably Potassium Acetate under pyrolysis conditions, or
a sorbent particle comprising potassium loaded nano-cellulose fibers imbedded in a High Accessibility Inorganic, preferably Alumina, binder sorbent system, wherein the nano-cellulose is partially or fully carbonized in-situ to form Carbon fibers or
Potassium loaded biomass based nano-cellulose and/or lignin imbedded in a High Accessibility Inorganic, preferably Alumina, binder sorbent system, wherein the nano-cellulose and/or lignin is partially or fully carbonized in-situ to form Carbon fibers.

23. A process to capture CO₂ wherein CO₂ is captured from flue gas from combustion or even directly from air.
